(19) United States
(12) Patent Application Publication
(10) Pub. No.: US 2025/0306206 A1
(43) Pub. Date: Oct. 2, 2025

(54) METHODS AND SYSTEMS OF LIGHT DETECTING AND RANGING

(71) Applicant: SEMICONDUCTOR COMPONENTS INDUSTRIES, LLC, Scottsdale, AZ (US)

(72) Inventor: Gal FADIDA, Odem (IL)

(73) Assignee: SEMICONDUCTOR COMPONENTS INDUSTRIES, LLC, Scottsdale, AZ (US)

(21) Appl. No.: 18/621,005

(22) Filed: Mar. 28, 2024

(51) Int. Cl. G01S 17/18; G01S 7/4863; G01S 7/4865

(52) U.S. Cl. CPC G01S 17/18; G01S 7/4863; G01S 7/4865

(57) ABSTRACT

Light detecting and ranging. One example is a method of performing light detection and ranging (LIDAR), the method comprising: illuminating a scene along a first direction with first interrogating infrared, the illuminating results in first reflected infrared, the first reflected infrared reflected from a first object disposed within the scene; activating a plurality of pixels such that each pixel of the plurality of pixels is sensitive to the first reflected infrared during respective first activation periods; creating, by each pixel, a first signal that is proportional to a number of photons of the reflected infrared absorbed by each pixel, the creating results in a plurality of first signals; and estimating a distance to the first object based on an amplitude of at least one of the plurality of first signals.

### CROSS-REFERENCE TO RELATED APPLICATIONS

None

### BACKGROUND

Many systems use light detection and ranging (LIDAR) to implement vision-like control. Such systems include weapons systems, mobile autonomous robots, safety systems for automobiles, and semi-autonomous and autonomous driving systems.

Lidar systems are time-of-flight systems. Light, such as near infrared, is directed into the scene of interest. The light propagates outward and reflects from objects within the scene. The reflected light travels back to a detection system, and based on the round trip time-of-flight of the light, the distance to objects within the scene may be determined.

Related-art LIDAR systems are thus primarily concerned with timing of the arrival of reflected light, and not necessarily the number of photons of the reflected light received. For that reason, related-art LIDAR system use photodetectors arranged for avalanche breakdown. That is, related-art LIDAR systems use single photon avalanche detector (SPAD) or silicon photomultiplier (SiPM) systems to detect arrival of the reflected light. Avalanche detectors and silicon photomultipliers effectively apply high gain to the photon detection—in some cases a single photon may cause the avalanche breakdown within the detector.

### SUMMARY

One example is a method of performing light detection and ranging (LIDAR), the method comprising: illuminating a scene along a first direction with first interrogating infrared, the illuminating results in first reflected infrared, the first reflected infrared reflected from a first object disposed within the scene; activating a plurality of pixels such that each pixel of the plurality of pixels is sensitive to the first reflected infrared during respective first activation periods; creating, by each pixel, a first signal that is proportional to a number of photons of the reflected infrared absorbed by each pixel, the creating results in a plurality of first signals; and estimating a distance to the first object based on an amplitude of at least one of the plurality of first signals.

The example method may further comprise, outside of each pixel's respective first activation period, deactivating each pixel of the plurality of pixels such that each pixel is insensitive to the first reflected infrared.

In the example method, activating the plurality of pixels may comprise sequentially activating each pixel of the plurality of pixels.

In the example method, activating the plurality of pixels may comprise: activating, during respective first activation periods, each pixel to generate electrons responsive to the number of photons of the first reflected infrared absorbed by each pixel; and deactivating, outside of each respective first activation period, each pixel of the plurality of pixels such that each pixel is insensitive to the first reflected infrared.

The example method may further comprise: illuminating the scene along the first direction with second interrogating infrared; and activating each pixel of the plurality of pixels such that each pixel supplements its respective first signal proportional to a second reflected infrared that arrives within respective second activation periods. The example method may further comprise, after illuminating the scene with the second interrogating infrared and activating each pixel of the plurality of pixels such that each pixel supplements its respective first signal, transferring each first signal to a respective memory capacitor.

The example method may further comprise: illuminating the scene along a second direction with second interrogating infrared, the illuminating results in second reflected infrared, a second reflected infrared reflected from the first object disposed within the scene; activating the plurality of pixels such that each pixel is sensitive to the second reflected infrared during respective second activation periods; creating, by each pixel, a second signal that is proportional to a number of photons of the second reflected infrared absorbed by each pixel, the creating results in a plurality of second signals; and estimating a distance to the first object based on an amplitude of at least one of the plurality of first signals and at least one of the plurality of second signals.

In the example method, activating the plurality of pixels may comprise at least one selected from a group comprising: each pixel is activated for a trigger period that does not overlap with other pixels; each pixel is activated for a trigger period that overlaps a trigger period of a contiguous pixel of the plurality of pixels.

In the example method, illuminating the scene may comprises at least one selected from a group comprising: illuminating the scene with a laser dot along the first direction; illuminating the scene with a laser line along the first direction; illuminating the scene with the laser line that is vertically orientated; and illuminating the scene with the laser line that is horizontally orientated.

Yet another example may be a light detection and ranging (LIDAR) sensor, the sensor comprising: a first plurality of pixels including one or more shutter transistors, one or more photodetectors, one or more transfer transistors, one or more floating diffusions, and one or more memory capacitors; a row controller coupled to the first plurality of pixels, the row controller configured to arrange the first plurality of pixels for readout; a column controller coupled the first plurality of pixels, the column controller configured to read signals from each pixel of the first plurality of pixels; and a gating controller coupled to the first plurality of pixels, the gating controller configured to gate each pixel of the first plurality of pixels such that each pixel is sensitive to reflected infrared during respective activation periods, and insensitive to reflected infrared outside of the respective activation periods.

In the example LIDAR sensor, the gating controller defines a timing signal input, and the gating controller may be configured to extract a sample period from a timing signal applied to the gating controller, and gate each pixel within the sample period.

In the example LIDAR sensor, when the gating controller gates each pixel, the gating controller may be configured to, for each pixel: outside the activation period, make a corresponding shutter transistor conductive, which makes the pixel insensitive to reflected infrared; and during the activation period, make a corresponding shutter transistor non-conductive and make a corresponding transfer transistor conductive such that electrons generated by the photodetector responsive to reflected infrared modify a voltage on the floating diffusion. The row controller may be further configured to, for each pixel of the plurality of pixels and after the gating controller gates each pixel in a sample period, drive a voltage to a corresponding memory capacitor proportional to the voltage on the floating diffusion.

In the example LIDAR sensor, when the gating controller gates each pixel, the gating controller may be configured to gate each pixel such that the activation periods are mutually exclusive.

In the example LIDAR sensor, when the gating controller gates each pixel, the gating controller may be configured to gate each pixel such that, as between two pixels of the plurality of pixels, the activation periods at least partially overlap.

The example LIDAR sensor may further comprise: a second plurality of pixels includes one or more second shutter transistors, one or more second photodetectors, one or more second transfer transistors, one or more second floating diffusions, and one or more second memory capacitors; the row controller coupled to the second plurality of pixels, and the row controller configured to arrange the second plurality of pixels for read out; the column controller coupled the second plurality of pixels, and the column controller configured to read signals generated by the photodetector of each pixel of the second plurality of pixels; and the gating controller coupled to each pixel of the second plurality of pixels, the gating controller configured to gate each pixel of the second plurality of pixels such that each pixel of the second plurality of pixels is sensitive to reflected infrared during respective activation periods and insensitive to reflected infrared outside of the respective activation periods.

Yet another example is a LIDAR system comprising: a LIDAR controller; a LIDAR source coupled to the LIDAR controller, the LIDAR source configured to send interrogating light into a scene responsive to commands from the LIDAR controller; and a LIDAR sensor coupled to the LIDAR controller. The LIDAR sensor may comprise: a first plurality of pixels; a row controller coupled to the first plurality of pixels, the row controller configured to arrange the first plurality of pixels for readout; a column controller coupled the first plurality of pixels, the column controller configured to read sample signals from each pixel of the first plurality of pixels; and a gating controller coupled to each pixel of the first plurality of pixels, the gating controller configured to gate the first plurality of pixels such that each pixel is sensitive to reflected infrared during respective activation periods, and insensitive to reflected infrared outside of the respective activation periods, The LIDAR controller may be configured to acquire, from the LIDAR sensor, a histogram of sample signals, and estimate a distance to a reflecting object based on an amplitude of the sample signals of the histogram.

In the example LIDAR system, when the gating controller gates each pixel, the gating controller may be configured to, for each pixel: outside the activation period, make a shutter transistor of the pixel conductive, which makes the pixel insensitive to reflected infrared; and during the activation period, make the shutter transistor non-conductive and make a transfer transistor of the pixel conductive such that electrons generated by the photodetector responsive to reflected infrared modify a voltage on the floating diffusion. The row controller may be further configured to, for each pixel of the plurality of pixels and after the gating controller gates each pixel in sample period, transfer a representation of a the voltage on a floating diffusion of the pixel to a memory capacitor of the pixel.

In the example LIDAR system, when the gating controller gates each pixel of the plurality of pixels, the gating controller may be configured to gate each pixel such that the activation periods are mutually exclusive.

In the example LIDAR system, when the gating controller gates each pixel of the plurality of pixels, the gating controller is configured to gate each pixel such that, as between two pixels of the plurality of pixels, the activation periods at least partially overlap.

The example LIDAR system may further comprise: a second plurality of pixels; the row controller coupled to the second plurality of pixels, and the row controller configured to arrange the second plurality of pixels for read out; the column controller coupled the second plurality of pixels, and the column controller configured to read signals generated by the photodetector of each pixel of the second plurality of pixels; and the gating controller coupled to each pixel of the second plurality of pixels. The gating controller may be configured to gate each pixel of the second plurality of pixels such that each pixel of the second plurality of pixels is sensitive to reflected infrared during respective activation periods and insensitive to reflected infrared outside of the respective activation periods.

### BRIEF DESCRIPTION OF THE DRAWINGS

For a detailed description of example embodiments, reference will now be made to the accompanying drawings in which:

FIG. 1 shows a block diagram of a LIDAR system in accordance with at least some embodiments;

FIG. 2 shows an example LIDAR system in the form of a vehicle, in accordance with at least some embodiments;

FIG. 3 show a block diagram of a LIDAR sensor in accordance with at least some embodiments;

FIG. 4 shows an electrical schematic of a pixel in accordance with at least some embodiments;

FIG. 5 shows a timing diagram in accordance with at least some embodiments;

FIG. 6 shows a histogram in accordance with at least some embodiments; and

FIG. 7 shows a method in accordance with at least some embodiments.

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions. To be clear, an initial reference to “a [referent]”, and then a later reference for antecedent basis purposes to “the [referent]”, shall not obviate that the recited referent may be plural.

“About” in reference to a recited parameter shall mean the recited parameter plus or minus ten percent (+/−10%) of the recited parameter.

“Assert” shall mean creating or maintaining a first predetermined state of a Boolean signal. Boolean signals may be asserted high or with a higher voltage, and Boolean signals may be asserted low or with a lower voltage, at the discretion of the circuit designer. Similarly, “de-assert” shall mean creating or maintaining a second predetermined state of the Boolean, opposite the asserted state.

In relation to electrical devices, whether stand alone or as part of an integrated circuit, the terms “input” and “output” refer to electrical connections to the electrical devices, and shall not be read as verbs requiring action. For example, a comparator, such as an operational amplifier, may have a first input and a second input. These “inputs” define electrical connections to the comparator, and shall not necessarily be read to require inputting signals to the comparator.

“Controller” shall mean, alone or in combination, individual circuit components, an application specific integrated circuit (ASIC), a microcontroller with controlling software, a reduced-instruction-set computer (RISC) with controlling software, a digital signal processor (DSP), a processor with controlling software, a programmable logic device (PLD), a field programmable gate array (FPGA), or a programmable system-on-a-chip (PSOC), configured to read inputs and drive outputs responsive to the inputs.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various examples are directed to methods and systems of light detecting and ranging (LIDAR). More particular, various examples are directed to LIDAR systems in which the sensors do not use single photon avalanche detectors (SPADs) or silicon photomultipliers (SiPMs) for detection, as SPAD/SIPM devices mask information regarding the number of photons received. More particular still, various examples are directed to operating sensors such that time of flight information is encoded in the identity of the pixels that receive reflected light, and not necessarily in the direct timing of arrival of the reflected light at the sensor in general. It follows that the spatial information, being the identity of the pixels that receive reflected light during their respective activation periods, can then be correlated to the time of flight of the reflected light and thus the distance to the reflecting object. Yet more particularly still, various examples generate gating signals applied to the pixels of a row of a sensor. Each pixel is active and capable of generating a detection signal during periods of time when the pixel's gate signal is asserted. When a pixel's gate signal is de-asserted, photon arrival information is discarded. The distance to the object may then be directly inferred from the pixel or pixels whose detection signals indicate reflected light arrival greater than a predetermined threshold. The specification turns to an example system to orient the reader.

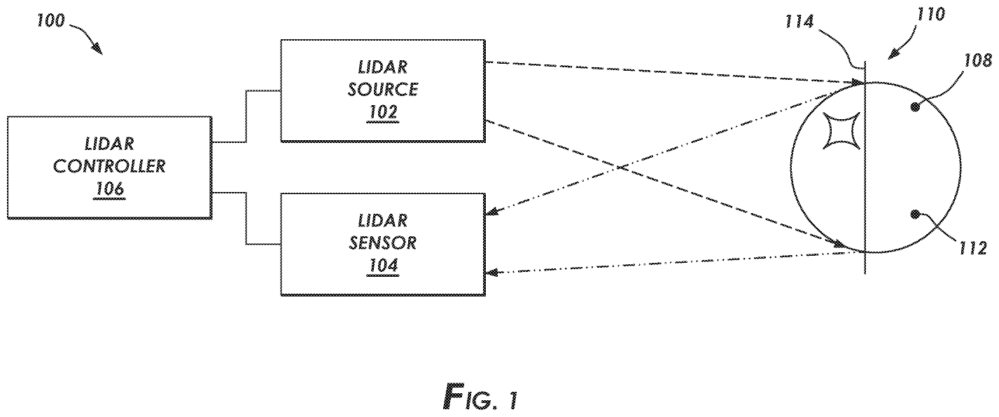

FIG. 1 shows, in block diagram form, an example LIDAR system 100. In particular, the example LIDAR system 100 comprises a LIDAR source 102, a LIDAR sensor 104, and a LIDAR controller 106. The example LIDAR source 102 is designed and constructed to direct interrogating light into a scene in front of the LIDAR source 102. The LIDAR source 102 may be any suitable source of light for use in a LIDAR system. In one example, the LIDAR source 102 comprises an array of laser diodes, such as an array of vertical-cavity surface-emitting laser (VCSEL) diodes. In some cases, the light created by the LIDAR source 102 is within the visible spectrum, but in other cases the light created is outside the visible spectrum, such infrared or near infrared. In one example, the interrogating light used to illuminate the scene may be infrared having a wavelength of 905 nanometers (nm) or 1550 nm. For convenience of the discussion that follows, the light created by the LIDAR source 102 is hereafter referred to as infrared or interrogating infrared, but with the understanding that the any suitable interrogating light may be used. Turning now to the LIDAR sensor 104.

The example LIDAR sensor 104 may comprise a plurality of pixels. As will be discussed in greater detail below, the pixels of the LIDAR sensor 104 may be organized into rows and columns. When properly configured, each pixel is sensitive to the arrival of the interrogating infrared that reflects from objects within the scene. Interrogating infrared that reflects from objects within the scene is hereafter referred to as reflected infrared. Turning now to the LIDAR controller 106.

The example LIDAR controller 106 is coupled to the LIDAR source 102 to control the timing of generating and release of interrogating infrared. Moreover, the LIDAR controller 106 is coupled to the LIDAR sensor 104 such that the LIDAR controller 106 reads one or more histograms from the LIDAR sensor 104. Based on an analysis of the one or more histograms, the LIDAR controller 106 determines the combined time-of-flight of the outgoing interrogating infrared and returning reflected infrared.

The example LIDAR source 102 illuminates the scene with interrogating infrared. However, for LIDAR systems, the interrogating infrared does not simultaneously illuminate the entire scene. Rather, in the example LIDAR system 100 the LIDAR source 102 selectively illuminates the scene in particular directions, and by repetitively illuminating the scene along incrementally varying directions, ultimately the entire scene is illuminated in a piecewise fashion. The steering of the interrogating infrared may take any suitable form, such as a solid-state LIDAR source 102 that steers the interrogating infrared by selective operation of a phased array source, or a mechanical system in which the interrogating infrared is steered or directed by movable lenses and/or mirrors.

In one example, the LIDAR source 102 may illuminate the scene using a series of laser “dots” launched from the LIDAR source 102. For example, the LIDAR source 102 may be designed and constructed to generate a first interrogating infrared in the form of a dot 108. That is, the interrogating infrared is sent out in the form of a tight beam of infrared that intersects in example object within the scene, here with an example object shown as sphere 110. The dot 108 of interrogating infrared reflects back to the LIDAR sensor 104 to be used for determining the distance to the example sphere 110 at the location of the dot 108. Second interrogating infrared may be sent in the form of a second dot 112, and as before the dot 112 of infrared reflects back to the LIDAR sensor 104. By sequentially illuminating the scene with dots of interrogating infrared, the location and distance to objects within the scene, such as the example sphere 110, may be determined. Illuminating the scene with dots of interrogating infrared may be used when the LIDAR sensor 104 is a single “row” of pixels.

In other cases, the LIDAR source 102 may illuminate the scene using lines of interrogating infrared. For example, the LIDAR source 102 may be designed and constructed to generate first interrogating infrared in the form of line 114 of infrared. That is, the interrogating infrared is sent out in the form of a line of infrared that intersects the example sphere 110 at several locations. The example line 114 of infrared is shown as a vertical line, but in other cases the line 114 may be a horizontal line, or the line 114 may sweep the example sphere 110 at any suitable angle. The line 114 of interrogating infrared reflects back to the LIDAR sensor 104 to be used for determining distance to the object in the scene at the various locations intersected by the line 114. Thereafter, further interrogating infrared may be sent in the form of additional lines at locations offset from line 114. By sequentially illuminating the scene with lines of interrogating infrared, the location and distance to the example sphere 110 may be determined. Illuminating the scene with lines of interrogating infrared may be used when the LIDAR sensor 104 has multiple rows of pixels.

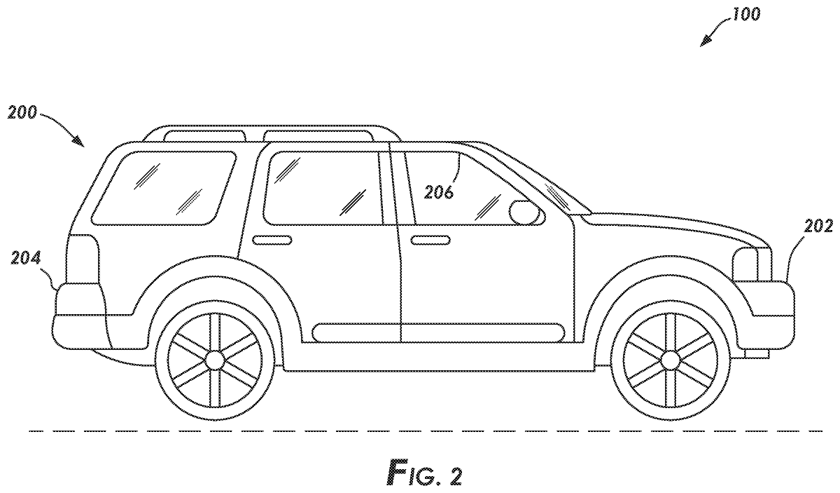

FIG. 2 shows another example of the LIDAR system 100. The LIDAR system 100 illustrated in FIG. 2 comprises an automobile or vehicle 200. The vehicle 200 is illustratively shown as a passenger vehicle, but the LIDAR system 100 may be other types of vehicles, including commercial vehicles, on-road vehicles, and off-road vehicles. Commercial vehicles may include busses and tractor-trailer vehicles. Off-road vehicles may include tractors and crop harvesting equipment. In the example of FIG. 2, the vehicle 200 includes a forward-looking LIDAR 202 arranged to capture images of scenes in front of the vehicle 200. Such forward-looking LIDAR 202 can be used for any suitable purpose, such as collision warning systems, distance-pacing cruise-control systems, autonomous driving systems, and proximity detection. The vehicle 200 further comprises a backward-looking LIDAR 204 arranged to capture images of scenes behind the vehicle 200. Such backward-looking LIDAR 204 can be used for any suitable purpose, such as collision warning systems, autonomous driving systems, proximity detection, monitoring position of overtaking vehicles, and backing up. The vehicle 200 further comprises a side-looking camera module 206 arranged to capture images of scenes beside the vehicle 200. Such side-looking camera module can be used for any suitable purpose, such as blind-spot monitoring, collision warning systems, autonomous driving systems, monitoring position of overtaking vehicles, lane-change detection, and proximity detection. In situations in which the LIDAR system 100 is a vehicle, the LIDAR controller 106 may be a controller of the vehicle 200. The discussion now turns in greater detail to the LIDAR sensor 104.

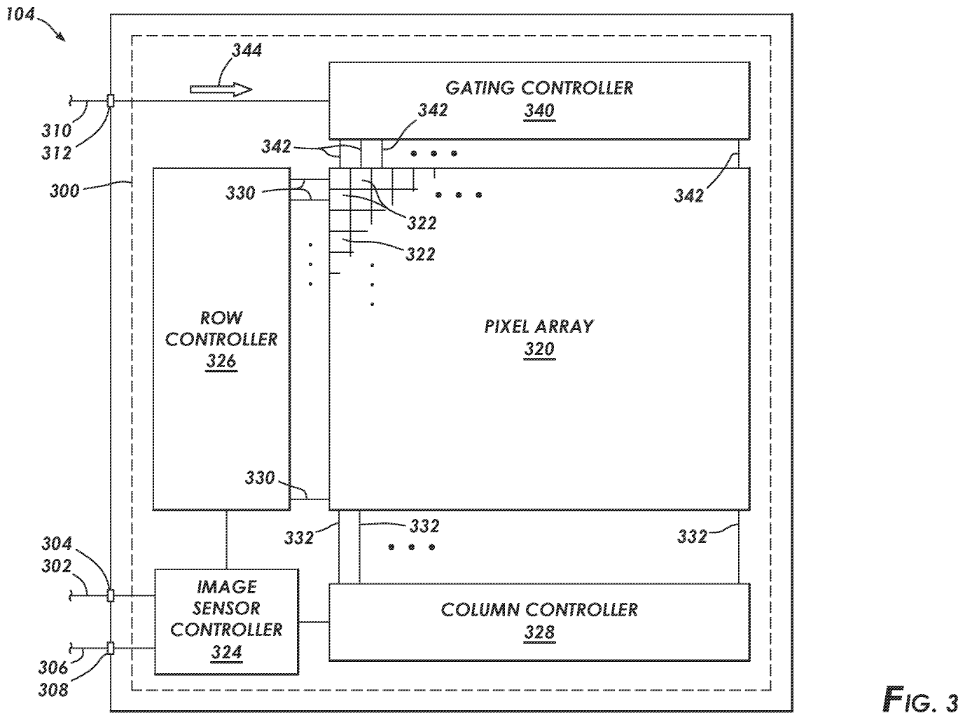

FIG. 3 shows an example LIDAR sensor 104. In particular, FIG. 3 shows that the LIDAR sensor 104 may comprise a substrate 300 of semiconductor material, such as silicon, encapsulated within packaging to create a packaged semiconductor device or packaged semiconductor product. Bond pads or other connection points of the substrate 300 couple to terminals of the LIDAR sensor 104. The connections may comprise a serial communication channel 302 coupled to terminal(s) 304, a capture input 306 coupled to terminal 308, and a phase lock input 310 coupled to terminal 312. Additional terminals will be present, such as ground, common, or power, but the additional terminals are omitted so as not to unduly complicate the figure. While a single instance of the substrate 300 is shown, in other cases multiple substrates may be combined to form the LIDAR sensor 104 in the form of a multi-chip module created before or after singulation.

The example LIDAR sensor 104 includes a pixel array 320 comprising a plurality of pixels, such as pixels 322 arranged in rows and columns. Pixel array 320 may comprise, for example, hundreds or thousands of rows and columns of pixels 322. Control and readout of the pixel array 320 may be implemented by an image sensor controller 324 coupled to a row controller 326 and a column controller 328. The row controller 326 may receive row addresses from the image sensor controller 324 and supply corresponding row control signals to the pixels 322, such as reset, row-select, charge transfer, and readout control signals. The row control signals may be communicated over one or more conductors, such as the row control paths 330.

Column controller 328 may be coupled to the pixel array 320 by way of one or more conductors, such as column lines 332. Column controllers may sometimes be referred to as a column control circuit, a readout circuit, or a column decoder. Column lines 332 may be used for reading out histograms from the pixels 322 and for supplying bias currents and/or bias voltages to the pixels 322. If desired, during readout operations, a pixel row in the pixel array 320 may be selected using row controller 326, and histograms generated by the pixels 322 in that pixel row can be read out along the column lines 332. The column controller 328 may include sample-and-hold circuitry for sampling and temporarily storing signals read out from the pixel array 320, amplifier circuitry, analog-to-digital conversion (ADC) circuitry, bias circuitry, column memory, latch circuitry for selectively enabling or disabling the column circuitry, or other circuitry that is coupled to one or more columns of pixels in the pixel array 320 for operating the pixels 322 and for reading out histograms from the pixel array 320. ADC circuitry in the column controller 328 may convert analog values received from the pixel array 320 into corresponding digital data. Column controller 328 may supply the histogram data to the image sensor controller 324. The image sensor controller 324 may determine the distance to reflected objects from the histogram data, or the image sensor controller 324 may supply the histogram data to the LIDAR controller 106 of FIG. 1 over the serial communication channel 302 for such determinations.

Still referring to FIG. 3, the example LIDAR sensor 104 comprises a gating controller 340. The gating controller 340 is shown in FIG. 3 as separate and distinct from the column controller 328; however, in other cases the functionality of the gating controller 340 may be incorporated within the column controller 328. The example gating controller 340 is coupled to the pixel array 320, and is designed and constructed to gate each pixel 322 of the pixel array 320 such that each pixel 322 is sensitive to reflected infrared during respective activation periods. In particular, the gating controller 340 defines the phase lock input 310, and the gating controller 340 is coupled to the pixel array 320 by way of gating paths 342. The gating controller 340 receives, by way of the phase lock input 310, a sample signal or timing signal 344 that defines a sample period. The timing signal 344 may take any suitable form, such as a square wave that defines the sample period as the period of the square wave, or a sinusoid that defines the sample period as the period of the sinusoid. By selective arrangement of the gating signals, and responsive to the timing signal 344, the gating controller 340 activates the pixels 322 of the pixel array 320 such that each pixel 322 is sensitive to reflected infrared during respective activation periods. Moreover, outside of each pixel's respective activation period, the gating controller 340 is designed and constructed to deactivate each pixel such that each pixel is insensitive to the reflected infrared. The aspects of the gating within respective activation periods are discussed more below, after introduction of an example pixel.

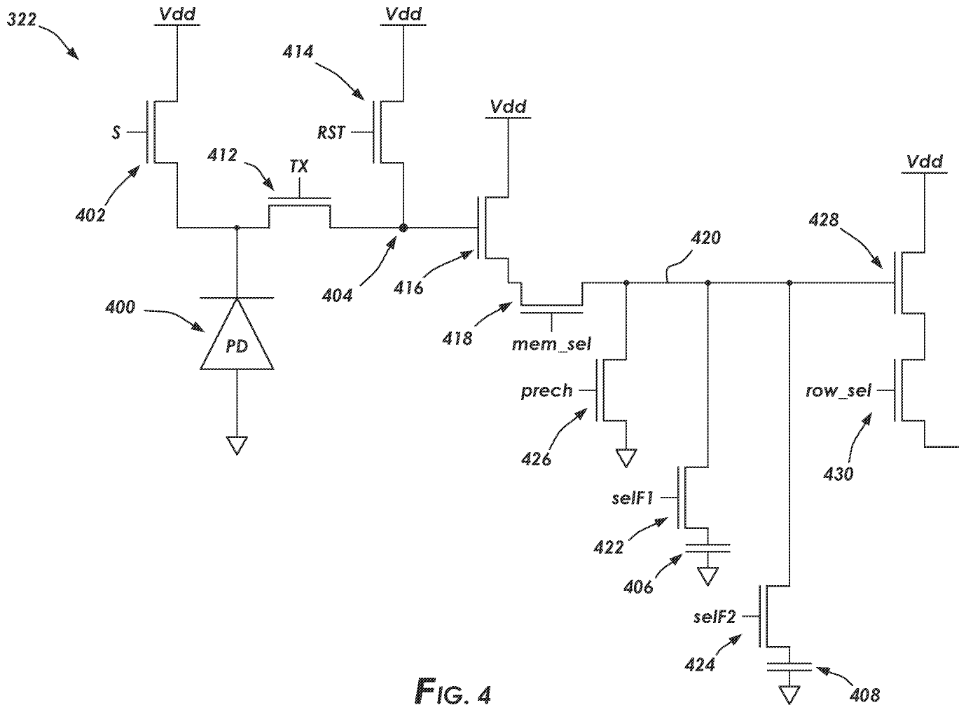

FIG. 4 shows an electrical schematic of a representative pixel 322. The pixel 322 is merely an example; in practice, the pixels may have fewer, additional, or different components in different configurations than the one illustrated in FIG. 4. In particular, the example pixel 322 comprises a photodetector 400, a shutter transistor 402, a floating diffusion 404, a first memory capacitor 406, and a second memory capacitor 408. The photodetector 400 defines an anode coupled to ground or common, and a cathode coupled to the source of the shutter transistor 402. A positive power supply voltage (Vdd) is coupled to the drain of the shutter transistor 402. When the gate of the shutter transistor 402 is asserted and the shutter transistor 402 is conductive, the positive power supply voltage Vdd is applied to the cathode of the photodetector 400, reverse biasing the photodetector 400. During periods of time when the shutter transistor 402 is conductive, the photodetector 400 is effectively insensitive to the arrival of reflected light. More particularly, during periods of time when the shutter transistor 402 is conductive, any reflected infrared incident upon the photodetector 400 creates electrons within the photodetector 400, but the electrons are immediately drawn away into the positive power supply voltage Vdd.

The example pixel includes a transfer transistor 412. The transfer transistor 412 defines a drain coupled to the floating diffusion 404, a source coupled to the cathode of the photodetector 400, and a gate. During periods of time when the example pixel 322 active, the shutter transistor 402 is non-conductive and the transfer transistor 412 is conductive, coupling the photodetector 400 to the floating diffusion 404.

The example pixel 322 includes a reset transistor 414. The reset transistor 414 defines a drain coupled to the positive power supply voltage Vdd, a source coupled to the floating diffusion, and a gate. During periods of time when the example reset transistor 414 is conductive, the voltage on the floating diffusion is reset by pulling the voltage up to the magnitude of the positive power supply voltage Vdd. Stated otherwise, in the example system the “reset” voltage for the floating diffusion 404 is about Vdd.

In order to transfer a voltage signal held on the floating diffusion 404, the floating diffusion 404 is coupled to a source-follower amplifier in the form of source-follower transistor 416. In particular, the gate of the source-follower transistor 416 is coupled to the floating diffusion 404, the drain is coupled to the positive power supply voltage Vdd, and the source is selectively coupled to the downstream components by way of the memory select transistor 418. The drain of the memory select transistor 418 is coupled to the source of the source-follower transistor 416, and the source of the memory select transistor 418 defines a memory node 420. Thus, signals created by the photodetector 400 and stored on the floating diffusion 404 may be transferred to the memory node 420 by way of the source-follower transistor 416, the memory select transistor 418, and a pre-charge transistor 426, which provides a load for the source-follower transistor 416. The memory node 420 enables the memory capacitors 406 and 408 to sample and hold voltages driven to the memory node 420.

The memory capacitor 406 is selectively coupled to the memory node 420 by way of select transistor 422 (selF1 in the figure). Similarly, the memory capacitor 408 is selectively coupled to the memory node 420 by way of a select transistor 424 (selF2 in the figure). The example pixel 322 further includes a pre-charge transistor 426. The pre-charge transistor 426 defines a drain coupled to the memory node 420, a source coupled to ground or common, and a gate. In order to reset or prepare the memory capacitors 406 and 408 for sampling operations, the pre-charge transistor 426 is made conductive along with the select transistors 422 and 424. Thus, the memory capacitors 406 and 408 may be reset to zero volts, or any tunable voltage.

Still referring to FIG. 4. In order to read out voltages from the memory capacitors 406 and 408, the example pixel 322 further includes another source-follower amplifier in the form of source-follower transistor 428. The source-follower transistor 428 defines a gate coupled to the memory node 420, a drain coupled to the positive power supply voltage Vdd, and a source. The source of the source-follower transistor 428 is coupled to a row select transistor 430 (row_sel in the figure). When the row select transistor 430 is conductive, the column controller 328 is able to individually read out the voltages stored on the memory capacitors 406 and 408. That is, the column controller 328 may read out the voltage stored on the memory capacitor 406 by making the select transistor 422 conductive, making the select transistor 424 non-conductive, and making the row select transistors 424 conductive. Similarly, the column controller 328 may read out the voltage stored on the memory capacitor 408 by making the select transistor 422 non-conductive, making the select transistor 424 conductive, and making the row select transistors 424 conductive.

Prior to use of the pixel array 320 to generate histograms of arrivals of reflected infrared, each pixel 322 may be reset. In particular, the reset of a pixel may occur by making the shutter transistor 402 conductive and the transfer transistor 412 non-conductive. The arrangement of the shutter transistor 402 and transfer transistor 412 thus apply the positive power supply voltage Vdd to the cathode of the photodetector 400, and as previously mentioned the arrangement makes the pixel 322 insensitive to reflected infrared. That is, with the positive power supply voltage Vdd coupled to the cathode of the photodetector 400, electrons generated by infrared incident upon the photodetector are swept away into the positive power supply voltage Vdd. Still considering reset actions, as part of the reset of the pixel 322, the reset transistor 414 is momentarily made conductive, which pulls the voltage on the floating diffusion 404 up to substantially match the voltage of the positive power supply voltage Vdd. On the memory capacitor side of the circuit, the memory capacitors 406 and 408 may be reset to zero or some other tunable voltage by making their respective select transistors 422 and 424 conductive and simultaneously making the pre-charge transistor 426 fully or partially conductive, which drains charge stored on the memory capacitors 406 and 408. All the noted reset actions may be implemented by any suitable portion of the LIDAR sensor 104, such as the row controller 326.

In various examples, each pixel 322 is activated by operation of the gating controller 340 of FIG. 3. In particular, the gating controller 340 is coupled to the gate of the shutter transistor 402 and the gate of the transfer transistor 412, and the gating controller 340 asserts the gates of the shutter transistor 402 and the transfer transistor 412 in a mutually exclusive fashion. When the pixel 322 is inactive, shutter transistor 402 is conductive and the transfer transistor 412 is non-conductive. However, during a gating period for the pixel 322, the gating controller 340 makes the shutter transistor 402 non-conductive and makes the transfer transistor 412 conductive. Thus, any reflected infrared that is incident upon the photodetector 400 during the gating period generates electrons in the photodetector 400. The electrons generated within the photodetector 400 reduce the voltage at the floating diffusion 404. It follows, a higher voltage at the floating diffusion 404 after a gating period indicates less reflected infrared arriving at the photodetector 400, and lower voltage at the floating diffusion 404 after a gating period indicates greater reflected infrared arriving at the photodetector 400.

In some cases, a single gating period generates sufficient charge accumulation on the floating diffusion 404. In such cases, the voltage on the floating diffusion 404 may be transferred to one of the memory capacitors 406 or 408, and then the floating diffusion 404 may be reset by momentary making the reset transistor 414 conductive. However, in other cases the illumination of the scene with interrogating infrared along a certain direction may be repeated multiple times, such as repeated 100 times or repeated 1000 times. Each time the illumination is repeated along a particular direction, the LIDAR sensor 104 may be designed and constructed to activate the pixel 322 such that the voltage at the floating diffusion 404 is supplemented by way the second and subsequent activations. After a predetermined number of iterations, the composite voltage on the floating diffusion may be transferred to the one of the memory capacitors 406 or 408.

Still referring to FIG. 4, the example pixel 322 having two memory capacitors 406 and 408 enables the LIDAR system 100 to take multiple readings before reading out the voltages. As will become clearer based on the further teachings below, having multiple storage elements within the pixel 322 enables use of multiple, different gating periods before reading out the results.

A few points to consider before proceeding. The example LIDAR system 100, which includes the pixel 322 as part the LIDAR sensor 104, is directed to illuminating a scene with interrogating infrared, and receiving reflected infrared. The reflected infrared creates an analog value on the floating diffusion 404, where the magnitude of the voltage on the floating diffusion is proportional to a number of photons received during an activation. More particularly, the magnitude of the voltage on the floating diffusion 404, pulled lower as more photons arrive, is inversely proportional to the number of photon arrivals at the photodetector 400 during each activation. Other LIDAR systems may use SPADs or SiPMs for detection in infrared. SPAD and SiPM detectors are arranged for avalanche operation—the photodetectors are biased to be on the verge of avalanche breakdown in the absence of incident infrared. The bias voltage used to place the SPADs and SiPMs on the verge of avalanche breakdown is considered high for complementary metal oxide semiconductor (CMOS) devices—the bias voltage being about 20V or more. Detecting the arrival of reflected infrared in avalanche system is achieved by detecting a voltage associated with the avalanche current, and thus the SPAD photodetectors are actively biased during the detection phase. Stated otherwise, during detection operations the SPADs and SIPMs are coupled to the positive power supply voltage Vdd.

By contrast, in the example pixel 322, during periods of time when the pixel 322 is inactive, the shutter transistor 402 is conductive and photodetector 400 is negatively biased by the positive power supply voltage Vdd. However, the bias provided by the positive power supply voltage Vdd is relatively low, such as 5V or less, and in some cases 3V or less. The bias supplied by the positive power supply voltage Vdd is insufficient for the photodetector 400 to experience avalanche breakdown in the presence of reflected infrared incident upon the photodetector 400. Moreover, during periods of time when the pixel 322 is activated, the active bias is removed by way of the shutter transistor 402 being non-conductive. Any negative bias experienced by the photodetector 400 when the pixel 322 is active is the bias voltage held by the inherent capacitance of the photodetector itself. Moreover, the bias is reduced as reflected infrared is incident upon the photodetector 400 and electrons are produced thereby. Stated otherwise, determining the arrival time of the reflected infrared is based in part on amplitude of the voltage on the floating diffusion 404 being proportional to the number of photons incident upon photodetector 400. However, SPADs/SIPMs mask the amplitudes because even a single photon may cause avalanche breakdown. Stated otherwise, the response of a SPAD/SIPM may be the same for a single photon of reflected infrared and 10,000 photons of reflected infrared.

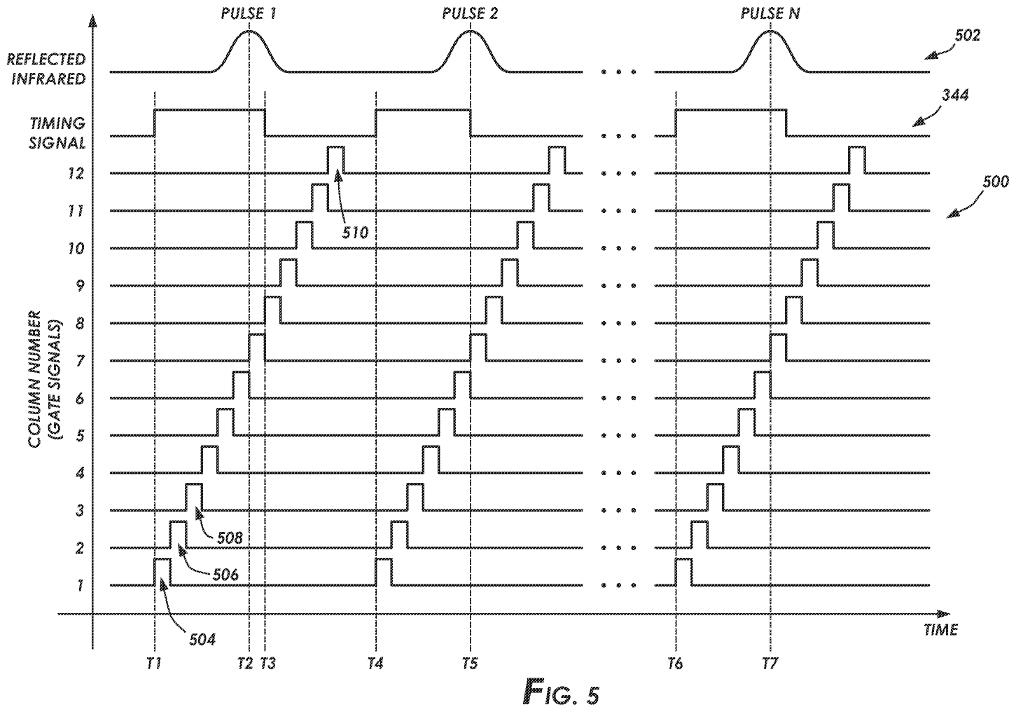

FIG. 5 shows an example timing diagram. In particular, FIG. 5 co-plots: gating signals 500 used to gate the pixels 322 of the pixel array 320; the timing signal 344 used to generate the gating signals 500; and an analog signal indicative of reflected infrared 502 incident upon the pixel array 320. The example timing diagram assumes each row of the pixel array 320 has twelve columns, hence the numbers 1 through 12 on the vertical axis; however, having twelve columns is merely an example to simplify the discussion. In practice, each row of the pixel array 320 may have many hundreds or thousands of columns.

Consider, for purposes of explanation, that the timing signal 344 is generated by the LIDAR controller 106 and provided to the gating controller 340. The example timing signal 344 goes asserted at time T1, goes de-asserted at time T3, and goes asserted again at time T4. Here, the timing signal is shown as a square wave, but any timing signal may be used as long as the timing signal defines a period being the inverse of the frequency. The period of the timing signal 344 is defined as the duration between corresponding features of the timing signal 344. In FIG. 3, the corresponding features may be the transitions to the asserted state at times T1 and T4, but any corresponding features may be used, such as the transitions to the de-asserted states at times T3 and T5.

Further consider that the interrogating infrared, not specifically shown or plotted, is released along a particular direction at time T1, again at time T4, and again at time T6. Each burst of the interrogating infrared propagates into the scene, and the interrogating infrared is reflected by objects in the scene. The reflected infrared propagates back to the pixel array 320 of the LIDAR sensor 104. Consider first the interrogating infrared released at time T1, which results in photons of the reflected infrared being incident upon the pixel array 320 with the peak of the first set of photon arrivals at time T2. Similarly, the second interrogating infrared is released at time T4, which results in photons of reflected infrared arriving at the pixel array 320 with the peak of the second set of photon arrivals at time T5. Finally, the third interrogating infrared is released at time T6, which results in photons of reflected infrared arriving at the pixel array 320 and with the peak of the third set of photon arrivals at time T7.

The arrivals of the reflected infrared at times T3, T5, and T7 are merely illustrative. The arrival time of the reflected infrared is directly dependent upon the distance between the reflecting object and the LIDAR sensor 104. If the reflecting object is close to the LIDAR sensor 104, the arrival times will be shifted earlier in time. If the reflecting object is further from the LIDAR sensor 104, the arrival times will be shifted later time. Thus, there is no causal connection between the arrival of the reflected infrared and the transition to non-asserted of example timing signal 344 at times T3, T5, and T7.

Still referring to FIG. 5, the gating signals 500 are generated by the gating controller 340 based on the timing signal 344. In particular, the gating controller 340 is provided at least one full period of the timing signal 344 prior to time T1. The gating controller 340 extracts the setpoint period from the at least one prior period of the timing signal 344, and then the gating controller 340 generates the gating signals 500 based on the setpoint period and the state transitions of the timing signal 344 during the current period. The gating controller 340 may use any suitable system to extract the setpoint period and generate the gating signals 500, such as the delay-locked loop (DLL) described in commonly-assigned U.S. application Ser. No. 18/062,920 filed 7 Dec. 2022.

Referring specifically to the gating signal associated with column 1, being gating signal 504. In particular, the gating controller 340 generates a gating signal 504, which goes asserted at time T1. The gating signal 504 is shown as asserted high, but any asserted state may be used, such as asserted low. The gating controller 340 is designed and constructed to de-assert the gating signal 504, and then assert the gating signal 506 associated with column 2. The gating controller 340 is designed and constructed to de-assert the gating signal 506, and then assert the gating signal 508 associated with column 3. The process repeats within the setpoint period for each column, ending with the gating controller 340 asserting the gating signal 510 associated with column 12. Thus, in the example system the gating signals 500 are asserted sequentially, starting at column 1. However, the starting column need not be column 1, and the gating may start at any column, such as the highest numbered column.

Moreover, the example gating signals 500 are asserted such that their trigger time or trigger periods do not overlap. Stated otherwise, in the example of FIG. 5, the gating signals 500 are asserted mutually exclusively. For example, the asserted time or asserted duration of gating signal 504 does not overlap the asserted time of gating signal 506. In yet still further examples, the trigger time of gating signals may overlap. For example, the gating signal 504 may go de-asserted after the gating signal 506 goes asserted. The gating signal 506 may go de-asserted after the gating signal 508 goes asserted, and so on. Having overlapping gating signals smooths out the histogram and has the benefit as using more pixel area to collect information. As the goal is to extract a peak from the histogram, discussed more below, a peak can still be extracted from a smoothed histogram. One benefit of overlapping gating signals is less time is needed to gather the signal. Stated otherwise, if there is overlap of the gating signals, the information used to determine the peak comes from more than one pixel.

The asserted states of the gating signals 500 are thus representative of respective time periods in which each pixel is sensitive to the arrival of photons of reflected infrared. Oppositely, the de-asserted states are thus representative of respective time periods in which each pixel is insensitive to the arrival of photons of reflected infrared. That is to say, while the photodetectors within each pixel may generate electrons responsive to photons of reflected infrared at any time, when the cathode of the photodetector is coupled to the positive power supply voltage Vdd, the generated electrons are swept to the positive power supply voltage Vdd, and thus the overall pixel is insensitive to the reflected infrared. As discussed with respect to FIG. 4, arranging a pixel to be sensitive to the arrival of photons of reflected infrared involves making the shutter transistor 402 non-conductive and making the transfer transistor 412 conductive. Thus, for each pixel 322, additional circuitry may be present to oppositely drive the gates of the shutter transistor 402 and the transfer transistor 412 responsive to the pixel's gating signal.

Further, consider that the timing diagram of FIG. 5 is representative of sending out multiple pulses of interrogating infrared along a single, particular direction. That is, during the first period between times T1 and T4, a first interrogating infrared is sent out in the particular direction, and the object in the scene results in the first reflected infrared centered at time T2. During the second period beginning at time T4, a second interrogating infrared is sent out again in the particular direction, and the object in the scene results in the second reflected infrared centered at time T5. During the Nth period beginning at time T6, an Nth interrogating infrared is sent out in the particular direction, and the object in the scene results in the Nth reflected infrared centered at time T7. The variable N may be any non-zero positive integer, such as 100 or 1000.

In various examples, the round trip travel time of the infrared is not directly timed. Rather, the magnitude of the signals created by the respective pixels is indicative of the arrival of the reflected infrared, and the identity of the pixels having signals of non-trivial magnitude are indicative of distance to the reflecting object. For example, the signals created by pixels of columns 1-5 will indicate relatively few photon arrivals during their respective activation periods. By contrast, the signals created by pixels of columns 6 and 7 will indicate significantly more photon arrivals during their respective activation periods. The signals created by pixels of columns 8-12 will indicate few photon arrivals during their respective activation periods. Thus, the distance to the reflecting object may be determined based on the identity of pixels, such as each pixel's column number, whose signals indicate arrival of photons of reflected energy greater than a threshold. Stated otherwise, the distance to the reflecting object may be estimated based on an amplitude of the signals of at least one of the pixels 322. Thus, the determination of arrival time thus need not be directly timed.

There are many variations in the construction of the pixel array 320 and the related operational aspects of creating and reading out histograms. The specification now turns to example operational techniques for various arrangements. Consider first that the pixel array has only a single “row” of pixels, defining a plurality of “columns.” For purposes of discussion, the columns of the single row are assumed to be contiguous and define a “horizontal” row; however, in the case of a LIDAR sensor 104 having only a single row of pixels, the “columns” need not define a horizontal row—for example, the “columns” may be arranged in a circle or a spiral. Thus, the terms “row” and “column” should not necessarily be read to define physical orientations of the pixels 322 in the pixel array 320.

Using a pixel array 320 comprising a single row of pixels 322 may limit the amount of information that can be gleaned from reflected infrared. That is, the LIDAR sensor 104 is responsive to reflected infrared from anywhere in scene. Thus, when using a pixel array 320 comprising a single row, the interrogating infrared is a series of laser “dots” launched from the LIDAR source 102. It follows that, when using interrogating infrared in the form of dots, the reflected infrared comes only from the location within the scene illuminated by the dot. To illuminate the entire scene, a plurality of laser dots may be launched in different directions to cover the entire scene over time. For example, N dots may be launched along a first particular direction, and then N dots may be launched along a second direction, incrementally different than the first direction, and so on, until the entire scene is illuminated with interrogating infrared.

Consider now that N dots of interrogating energy are sent out along a first particular direction. Each time the interrogating infrared is sent out in the form of a dot, each pixel 322 is active in respective activation periods. Reflected infrared, if any, from the location of the illumination will be incident upon the respective photodetectors. Thus, the first pixel in the column modifies the voltage on its floating diffusion during each activation period of the first pixel. The second pixel in the column modifies the voltage on its floating diffusion during each activation period of the second pixel. In the example of twelve columns, the twelfth pixel in the column modifies the voltage on its floating diffusion during each activation of the period of the twelfth pixel. After the N dots of interrogating infrared are sent along the particular direction: the example LIDAR sensor 104 may transfer voltage on the floating diffusion 404 of the first pixel to a memory capacitor, such as memory capacitor 406 within the first pixel; the example LIDAR sensor 104 may transfer voltage on the floating diffusion of the second pixel to the memory capacitor 406 of the second pixel; and so on, including the example LIDAR sensor 104 may transfer voltage on the floating diffusion of the twelfth pixel to the memory capacitor 406 of the twelfth pixel.

After the sending of N dots of interrogating infrared, and transferring the respective voltages on the floating diffusions to respective memory capacitors, the voltages stored on the memory capacitors as a group can be thought of as a histogram of photon arrival information. By the column controller 328 reading out the voltages stored on the memory capacitors, the column controller 328 and/or the LIDAR controller 106 read a histogram of arrival data from which the distance to the reflecting objects can be determined.

In accordance with at least some examples, before incrementing the direction out which the interrogating energy is sent, the LIDAR system 100 may repeat sending the N dots of interrogating energy along the first direction, but this time with a different setpoint period defined by the timing signal 344. That is to say, the LIDAR system 100 does not necessarily know the location of reflecting objects within the scene. Some reflecting objects may be very close to the LIDAR sensor 104, and others may be far away. Thus, repeating the N dots of interrogating infrared with a different setpoint period may thus “focus” the data for particular distances. For example, the first N dots may be sent with the setpoint period selected to capture reflected infrared for any object out to a first predetermined distance. The second and subsequent N dots may be sent with the setpoint period selected to capture reflected infrared for objects within a second predetermined distance, closer than the first predetermined distance. The reflected infrared associated with the second and subsequent N dots modifies their respective floating diffusions, and the voltages of the respective floating diffusion may then be transferred to second respective memory capacitors, such as memory capacitors 408. It follows then, for later readout the column controller 328 may read out multiple histograms.

Another reason to repeat the N dots being sent along the particular direction is multiple reflections. That is to say, the interrogating infrared propagates outward, and the reflected infrared propagates toward the LIDAR sensor 104. However, the reflected infrared may itself reflect back into the scene, be reflected again by the objects in the scene, and then be incident again upon the pixel array 320. Thus, having multiple, different sample periods used to create the histograms may be useful in identifying and discarding multiple reflections, or just multiples, of the reflected infrared.

The sending of N dots of interrogating infrared may then be repeated for a plurality of incrementally different directions, and the subsequent series of N dots having a respective sample period. The column controller 328 may read out the histograms at any convenient time. If each pixel 322 has two memory capacitors, two sets of N dots may be sent, and then the histograms read out, before sending additional sets of N dots along the same or different particular directions. However, pixels 322 may have any number of memory capacitors, such as three or five, and thus more than two sets of sending N dots of interrogating infrared may be sent before readout.

The discussion now turns to operation of a pixel array 320 having multiple “rows” and aligned or substantially aligned columns, such as the layout implied in FIG. 3. For purposes of discussion, the pixels of each row are assumed to be contiguous and straight, and each column of pixels are assumed to be contiguous and straight. However, neither the rows nor the columns are required to be straight or contiguous.

Using a pixel array 320 comprising multiple rows and columns increases, compared the single row implementations, the amount of information that can be gleaned from arrival of the reflected infrared. Thus, when using a pixel array 320 comprising multiple rows and columns, the interrogating infrared may be a series of laser “lines” launched from the LIDAR source 102. It follows that, when using interrogating infrared in the form of laser lines, the reflected infrared comes only from the locations within the scene illuminated by the line. To illuminate the entire scene, a plurality of laser lines may be launched. For example, N laser lines may be launched along a first particular direction, and then N laser lines may be launched along second direction, incrementally different than the first direction, and so on, until the entire scene is illuminated with interrogating infrared.

Consider now that N laser lines of interrogating energy are sent out along a first particular direction. Each time the interrogating infrared is sent out in the form of a laser line, the pixels in each column are active in a respective activation period. For example, all the pixels in column 1 may be active in a first activation period, and then all the pixels in column 2 may be active in a second activation period, and so on. Reflected infrared, if any, from the locations of the laser lines will be incident upon the respective photodetectors. Thus, each pixel in column 1 modifies the voltage on its floating diffusion during the first activation period. Each pixel in column 2 modifies the voltage on its floating diffusion during the second activation period. In the example of twelve columns, all the pixels in the column 12 modify the voltage on their floating diffusions during the twelfth activation period. After the N laser lines of interrogating infrared are sent along the particular direction, the example LIDAR sensor 104 may transfer respective voltages on the respective floating diffusions to respective memory capacitors, such as memory capacitor 406 within each pixel.

Thus, after the sending of N laser lines of interrogating infrared, and for each pixel in the column transferring the respective voltages on the floating diffusions to respective memory capacitors, the voltages stored by the memory capacitors can be thought of as a histogram of photon arrival information. By the column controller 328 reading out the voltages stored on the memory capacitors, the column controller 328 and/or the LIDAR controller 106 read a histogram of arrival data from which the distance to the reflecting objects can be determined.

In accordance with at least some examples, before incrementing the direction out which the interrogating energy is sent, the LIDAR system 100 may repeat sending the N laser lines of interrogating energy along the first direction, but this time with a different setpoint period defined by the timing signal 344. Thus, repeating the N laser lines of interrogating infrared with a different setpoint period may thus “focus” the data for particular distances. For example, the first N laser lines may be sent with the setpoint period is selected to capture reflected infrared for any object out to a first predetermined distance. The second and subsequent N dots may be sent with the setpoint period selected to capture reflected infrared for objects within a second predetermined distance, closer than the first predetermined distance. The reflected infrared associated with the second and subsequent N laser lines modifies their respective floating diffusions, and the voltages of the respective floating diffusion may then be transferred to second respective memory capacitors, such as memory capacitors 408. It follows then, for later readout the column controller 328 may read out multiple histograms.

The sending of N laser lines of interrogating infrared may then be repeated for a plurality of incrementally different directions, and the series of N laser lines having a respective sample period. The column controller 328 may read out the histograms at any convenient time. If each pixel 322 has two memory capacitors, two sets of N laser lines may be sent, and then the histograms read out, before sending additional sets of N laser lines along the same or different particular directions. However, pixels 322 may have any number of memory capacitors, such as three or five, and thus more than two sets of sending N laser lines of interrogating infrared may be sent before readout.

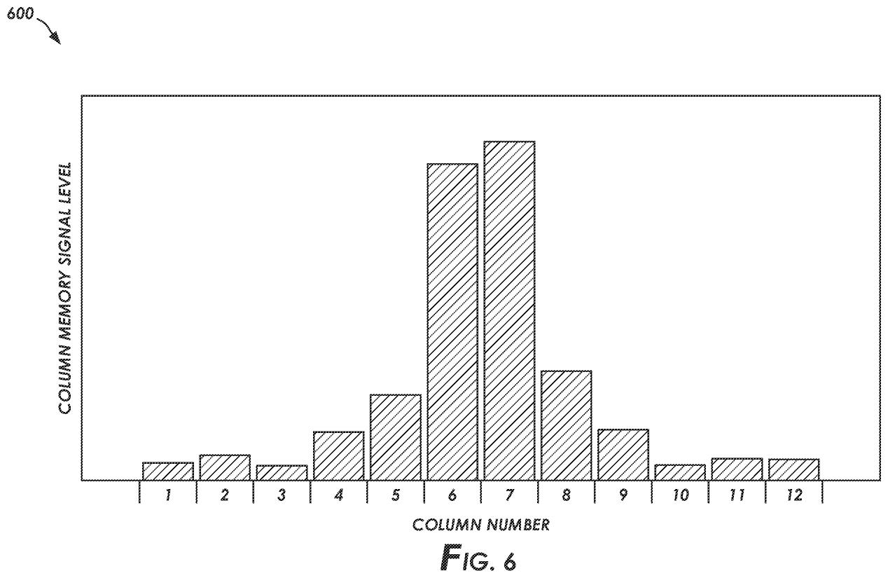

FIG. 6 shows an example histogram. In particular, FIG. 6 shows a histogram 600 of the signal level of memory capacitors (vertical axis) plotted against column number (horizontal axis). Staying consistent with FIG. 5, the example histogram has twelve columns, but again in practice a pixel array 320 may have hundreds or thousands of columns. Each column shows a bar graph indicative of photon arrivals during respective activation periods associated with each column. In practice, after reset a floating diffusion voltage starts with a high voltage, such as at the positive power supply voltage Vdd. As photons arrive during activation period(s), the electrons created responsive to the photons reduce the voltage at the floating diffusion. Moreover, the voltage on the floating diffusion is transferred to a memory capacitor without inversion. So in practice, a lower the voltage on the floating diffusion and/or memory capacitor indicates a higher number of the photons that arrived during respective activation periods, and vice versa. However, for ease of understanding, FIG. 6 inverts the levels so that the higher the level in each column, the greater the number of the photons that arrived during that column's activation period.

Determining the arrival time of reflected infrared is thus a two-step process. The signal level associated with each column is analyzed. If the signal level indicates photon arrivals greater than a threshold, indicating a peak, then the column identifier is indicative of the distance to the reflecting object. In this example, the signal levels associated with the columns 6 and 7 indicate photon arrivals greater than a threshold. Note that the determination regarding signal level can be made using a relatively simple analog-to-digital converter (ADC), such as a two- or three-bit ADC, or even a comparator. Stated otherwise, given that each sample period is known, the identity of the columns with signal levels indicating photon arrivals greater than a threshold directly indicate the distance to the reflecting object. In this way, the pixel of each column is effectively a depth-sensing pixel.

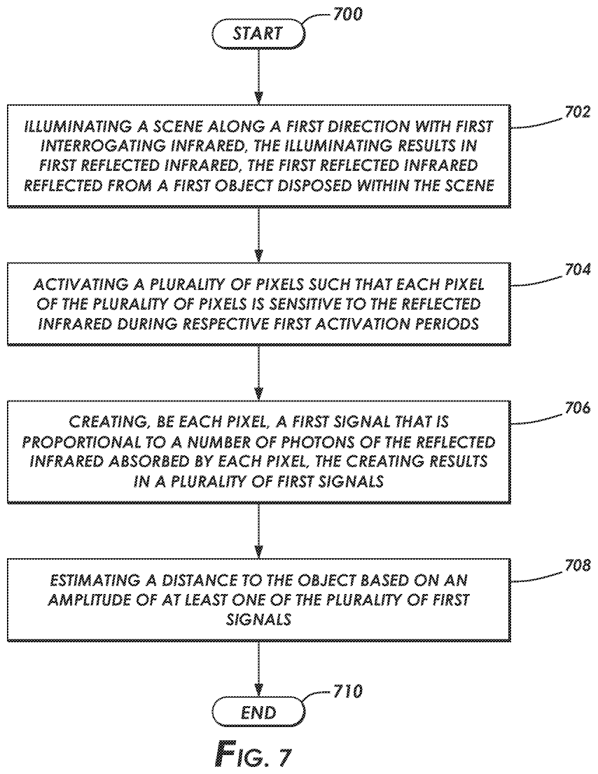

FIG. 7 shows an example method. In particular, the method starts (block 700) and comprises: illuminating a scene along a first direction with first interrogating infrared, the illuminating results in first reflected infrared, the first reflected infrared reflected from a first object disposed within the scene (block 702); activating a plurality of pixels such that each pixel of the plurality of pixels is sensitive to the reflected infrared during respective first activation periods (block 704); creating, by each pixel, a first signal that is proportional to a number of photons of the reflected infrared absorbed by each pixel, the creating results in a plurality of first signals (block 706); and estimating a distance to the object based on an amplitude of at least one of the plurality of first signals (block 708). Thereafter, the method ends (block 710), likely to be restarted for another series of illuminations along a duplicate path, or for another series of illuminations along a second path.

Many of the electrical connections in the drawings are shown as direct couplings having no intervening devices, but not expressly stated as such in the description above. Nevertheless, this paragraph shall serve as antecedent basis in the claims for referencing any electrical connection as “directly coupled” for electrical connections shown in the drawing with no intervening device(s).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of performing light detection and ranging (LIDAR), the method comprising:
illuminating a scene along a first direction with first interrogating infrared, the illuminating results in first reflected infrared, the first reflected infrared reflected from a first object disposed within the scene;
activating a plurality of pixels such that each pixel of the plurality of pixels is sensitive to the first reflected infrared during respective first activation periods;
creating, by each pixel, a first signal that is proportional to a number of photons of the reflected infrared absorbed by each pixel, the creating results in a plurality of first signals; and
estimating a distance to the first object based on an amplitude of at least one of the plurality of first signals.

2. The method of claim 1 further comprising, outside of each pixel's respective first activation period, deactivating each pixel of the plurality of pixels such that each pixel is insensitive to the first reflected infrared.

3. The method of claim 1, wherein activating the plurality of pixels comprises sequentially activating each pixel of the plurality of pixels.

4. The method of claim 1, wherein activating the plurality of pixels comprises:
activating, during respective first activation periods, each pixel to generate electrons responsive to the number of photons of the first reflected infrared absorbed by each pixel; and
deactivating, outside of each respective first activation period, each pixel of the plurality of pixels such that each pixel is insensitive to the first reflected infrared.

5. The method of claim 1 further comprising:
illuminating the scene along the first direction with second interrogating infrared; and
activating each pixel of the plurality of pixels such that each pixel supplements its respective first signal proportional to a second reflected infrared that arrives within respective second activation periods.

6. The method of claim 5 further comprising, after illuminating the scene with the second interrogating infrared and activating each pixel of the plurality of pixels such that each pixel supplements its respective first signal, transferring each first signal to a respective memory capacitor.

7. The method of claim 1 further comprising:
illuminating the scene along a second direction with second interrogating infrared, the illuminating results in second reflected infrared, a second reflected infrared reflected from the first object disposed within the scene;
activating the plurality of pixels such that each pixel is sensitive to the second reflected infrared during respective second activation periods;
creating, by each pixel, a second signal that is proportional to a number of photons of the second reflected infrared absorbed by each pixel, the creating results in a plurality of second signals; and
estimating a distance to the first object based on an amplitude of at least one of the plurality of first signals and at least one of the plurality of second signals.

8. The method of claim 1, wherein activating the plurality of pixels comprises at least one selected from a group comprising: each pixel is activated for a trigger period that does not overlap with other pixels; each pixel is activated for a trigger period that overlaps a trigger period of a contiguous pixel of the plurality of pixels.

9. The method of claim 1, wherein illuminating the scene comprises at least one selected from a group comprising:
illuminating the scene with a laser dot along the first direction;
illuminating the scene with a laser line along the first direction;
illuminating the scene with the laser line that is vertically orientated; and
illuminating the scene with the laser line that is horizontally orientated.

10. A light detection and ranging (LIDAR) sensor, the sensor comprising:
a first plurality of pixels including one or more shutter transistors, one or more photodetectors, one or more transfer transistors, one or more floating diffusions, and one or more memory capacitors;
a row controller coupled to the first plurality of pixels, the row controller configured to arrange the first plurality of pixels for readout;
a column controller coupled the first plurality of pixels, the column controller configured to read signals from each pixel of the first plurality of pixels; and
a gating controller coupled to the first plurality of pixels, the gating controller configured to gate each pixel of the first plurality of pixels such that each pixel is sensitive to reflected infrared during respective activation periods, and insensitive to reflected infrared outside of the respective activation periods.

11. The LIDAR sensor of claim 10, wherein the gating controller defines a timing signal input, and the gating controller is configured to extract a sample period from a timing signal applied to the gating controller, and gate each pixel within the sample period.

12. The LIDAR sensor of claim 10, wherein when the gating controller gates each pixel, the gating controller is configured to, for each pixel:
outside the activation period, make a corresponding shutter transistor conductive, which makes the pixel insensitive to reflected infrared; and
during the activation period, make a corresponding shutter transistor non-conductive and make a corresponding transfer transistor conductive such that electrons generated by the photodetector responsive to reflected infrared modify a voltage on the floating diffusion.

13. The LIDAR sensor of claim 12, wherein the row controller is further configured to, for each pixel of the plurality of pixels and after the gating controller gates each pixel in a sample period, drive a voltage to a corresponding memory capacitor proportional to the voltage on the floating diffusion.

14. The LIDAR sensor of claim 10, wherein when the gating controller gates each pixel, the gating controller is configured to gate each pixel such that the activation periods are mutually exclusive.

15. The LIDAR sensor of claim 10, wherein when the gating controller gates each pixel, the gating controller is configured to gate each pixel such that, as between two pixels of the plurality of pixels, the activation periods at least partially overlap.

16. The LIDAR sensor of claim 10, further comprising:
a second plurality of pixels includes one or more second shutter transistors, one or more second photodetectors, one or more second transfer transistors, one or more second floating diffusions, and one or more second memory capacitors;
the row controller coupled to the second plurality of pixels, and the row controller configured to arrange the second plurality of pixels for read out;
the column controller coupled the second plurality of pixels, and the column controller configured to read signals generated by the photodetector of each pixel of the second plurality of pixels; and
the gating controller coupled to each pixel of the second plurality of pixels, the gating controller configured to gate each pixel of the second plurality of pixels such that each pixel of the second plurality of pixels is sensitive to reflected infrared during respective activation periods and insensitive to reflected infrared outside of the respective activation periods.

17. A light detection and ranging (LIDAR) system comprising:
a LIDAR controller;
a LIDAR source coupled to the LIDAR controller, the LIDAR source configured to send interrogating light into a scene responsive to commands from the LIDAR controller;
a LIDAR sensor coupled to the LIDAR controller, the LIDAR sensor comprising:
a first plurality of pixels;
a row controller coupled to the first plurality of pixels, the row controller configured to arrange the first plurality of pixels for readout;
a column controller coupled the first plurality of pixels, the column controller configured to read sample signals from each pixel of the first plurality of pixels; and
a gating controller coupled to each pixel of the first plurality of pixels, the gating controller configured to gate the first plurality of pixels such that each pixel is sensitive to reflected infrared during respective activation periods, and insensitive to reflected infrared outside of the respective activation periods; and
the LIDAR controller is configured to acquire, from the LIDAR sensor, a histogram of sample signals, and estimate a distance to a reflecting object based on an amplitude of the sample signals of the histogram.

18. The LIDAR system of claim 17, wherein when the gating controller gates each pixel, the gating controller is configured to, for each pixel:
outside the activation period, make a shutter transistor of the pixel conductive, which makes the pixel insensitive to reflected infrared; and
during the activation period, make the shutter transistor non-conductive and make a transfer transistor of the pixel conductive such that electrons generated by the photodetector responsive to reflected infrared modify a voltage on the floating diffusion.

19. The LIDAR system of claim 18, wherein the row controller is further configured to, for each pixel of the plurality of pixels and after the gating controller gates each pixel in sample period, transfer a representation of a the voltage on a floating diffusion of the pixel to a memory capacitor of the pixel.

20. The LIDAR system of claim 17, wherein when the gating controller gates each pixel of the plurality of pixels, the gating controller is configured to gate each pixel such that the activation periods are mutually exclusive.

21. The LIDAR system of claim 17, wherein when the gating controller gates each pixel of the plurality of pixels, the gating controller is configured to gate each pixel such that, as between two pixels of the plurality of pixels, the activation periods at least partially overlap.

22. The LIDAR system of claim 17, further comprising:
a second plurality of pixels;
the row controller coupled to the second plurality of pixels, and the row controller configured to arrange the second plurality of pixels for read out;
the column controller coupled the second plurality of pixels, and the column controller configured to read signals generated by the photodetector of each pixel of the second plurality of pixels;
the gating controller coupled to each pixel of the second plurality of pixels, the gating controller configured to gate each pixel of the second plurality of pixels such that each pixel of the second plurality of pixels is sensitive to reflected infrared during respective activation periods and insensitive to reflected infrared outside of the respective activation periods.
